(19) United States
(12) Patent Application Publication
(10) Pub. No.: US 2026/0010775 A1
(43) Pub. Date: Jan. 8, 2026

(54) DEVICE AND METHOD WITH NEURAL NETWORK COMPILATION

(71) Applicants: Samsung Electronics Co., Ltd., Suwon-si (KR); UIF (University Industry Foundation), Yonsei University, Seoul (KR)

(72) Inventors: Gyeongmin LEE, Suwon-si (KR); Hanjun KIM, Seoul (KR); Seungbin Song, Seoul (KR); Hyunho KWON, Seoul (KR); Jaeho LEE, Seoul (KR); Jumin LEE, Seoul (KR); Haeeun JEONG, Seoul (KR)

(73) Assignees: Samsung Electronics Co., Ltd., Suwon-si (KR); UIF (University Industry Foundation), Yonsei University, Seoul (KR)

(21) Appl. No.: 19/233,673

(22) Filed: Jun. 10, 2025

(30) Foreign Application Priority Data
Jul. 4, 2024 (KR) 10-2024-0088419

(51) Int. Cl. G06N 3/0495; G06N 3/048

(52) U.S. Cl. CPC G06N 3/0495; G06N 3/048

(57) ABSTRACT

A device and method with neural network compilation is provided. The method includes detecting for a skip connection in a neural network, where the skip connection is configured to output first data to a second layer in the neural network, wherein the first data is output from a first layer in the neural network, and wherein the second layer is beyond a hierarchically subsequent layer of the first layer in the neural network, determining, in the neural network, a decompression layer set including a layer, which is configured in the neural network to be input second data with a dimension smaller a dimension of the first data, that is among one or more layers hierarchically preceding the first layer in the neural network, and generating a compiled version of the neural network by changing the skip connection dependent on the determined decompression layer set.

### CROSS-REFERENCE TO RELATED APPLICATIONS

This application claims the benefit under 35 USC § 119 (a) of Korean Patent Application No. 10-2024-0088419, filed on Jul. 4, 2024, in the Korean Intellectual Property Office, the entire disclosure of which is incorporated herein by reference for all purposes.

### BACKGROUND

### 1. Field

The following description relates to a device and method with neural network compilation.

### 2. Description of Related Art

A compiler may convert source code written in a programming language into object or machine code. A compiler may analyze the source code and generate the object or machine code based on results of the analysis.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a processor-implemented method includes detecting for a skip connection in a neural network, where the skip connection is configured to output first data to a second layer in the neural network, wherein the first data is output from a first layer in the neural network, and wherein the second layer is beyond a hierarchically subsequent layer of the first layer in the neural network, determining, in the neural network, a decompression layer set including a layer, which is configured in the neural network to be input second data with a dimension smaller a dimension of the first data, that is among one or more layers hierarchically preceding the first layer in the neural network, and generating a compiled version of the neural network by changing the skip connection dependent on the determined decompression layer set.

The determining of the decompression layer set may include detecting, among the one or more layers, the layer as a decompression layer that may be configured to be input data having a dimension smaller than the dimension of the first data by more than a threshold dimension, and determining all layers, sequentially from the decompression layer to the first layer in the neural network, as the decompression layer set.

The changing of the skip connection may include changing the detected skip connection, from the output of the first data from the first layer to the second layer, into a different skip connection using a copied layer set, which may be a copy of the determined decompression layer set, that may be configured to be input the second data and provide third data output from the copied layer set to the second layer.

The method may further include detecting, in the neural network, for an activation layer set including a decompression layer that may be configured to decompresses the second data, an activation layer that may be configured to apply an activation function to an output of the decompression layer, and a compression layer that may be configured to compress an output of the activation layer in the neural network, wherein the generating of the compiled version of the neural network may further include changing the detected activation layer set into a fusion layer that may be configured in the compiled version of the neural network to perform decompression, application of an activation function, and compression for each of tiles extracted from the second data.

The detecting for the activation layer set may include detecting for a concatenation layer set including a first decompression layer, a first activation layer that may be configured to apply a first activation function to an output of the first decompression layer, a second decompression layer, a second activation layer that configured to apply a second activation function to an output of the second decompression layer, a first concatenation layer that may be configured to concatenate an output of the first activation layer and an output of the second activation layer, and a compression layer that may be configured to compress an output of the first concatenation layer in the neural network, and wherein the changing of the detected activation layer set may include changing the detected concatenation layer set into the fusion layer, with the first decompression layer being the decompression layer, the first activation layer being the activation layer, and the first compression layer may be the compression layer, or the generating of the compiled version of the neural network may further include changing the detected concatenation layer set into another fusion layer that may be configured to performs a corresponding decompression, application of a corresponding activation function, and corresponding compression for each of tiles extracted from data that was configured in the neural network to be input to the concatenation layer set.

In response to a determination that the second layer is configured to concatenate an output of the first activation layer and an output of the second activation layer, detecting the second layer as the first concatenation layer and performing the changing of the detected concatenation layer set into the fusion layer, where the performing of the changing of the detected concatenation layer set into the fusion layer occurs after the changing of the skip connection, wherein changed skip connection may be configured to input the second data to the second decompression layer, and output a result of the second activation layer to the second layer, and wherein the detecting for the concatenation layer set may include detecting for the first decompression layer and the first activation layer between the first layer and the second layer in the neural network, and detecting for the second decompression layer and the second activation layer in the changed skip connection.

The method may further include detecting for a concatenation layer set including a first decompression layer, a first activation layer that may be configured to apply a first activation function to an output of the first decompression layer, a second decompression layer, a second activation layer that configured to apply a second activation function to an output of the second decompression layer, a first concatenation layer that may be configured to concatenate an output of the first activation layer and an output of the second activation layer, and a compression layer that may be configured to compress an output of the first concatenation layer in the neural network, where the detection of the second decompression layer and the detection of the second activation layers may be performed after performance of the changing the skip connection, and in response to the first activation function being determined to be same as the second activation function, replacing the concatenation layer set with a second concatenation layer that may be configured to concatenate an input of the first decompression layer and an input of the second decompression layer, and a fusion layer that may be configured to perform decompression, application of the first activation function, and compression for each of tiles extracted from an output of the second concatenation layer.

The method may further include detecting for a concatenation layer set including a first decompression layer, a first activation layer that may be configured to apply a first activation function to an output of the first decompression layer, a second decompression layer, a second activation layer that configured to apply a second activation function to an output of the second decompression layer, a first concatenation layer that may be configured to concatenate an output of the first activation layer and an output of the second activation layer, and a compression layer that may be configured to compress an output of the first concatenation layer in the neural network, where the detection of the second decompression layer and the detection of the second activation layers may be performed after performance of the changing the skip connection, and in response to a determination that the first activation function may be different from the second activation function, replacing the concatenation layer set with a first fusion layer that may be configured to perform decompression, application of the first activation function, and compression for each of tiles for an input of the first decompression layer, a second fusion layer that may be configured to perform decompression, application of the second activation function, and compression for each of tiles for an input of the second decompression layer, and a summation layer that may be configured to sum an output of the first fusion layer and an output of the second fusion layer.

The detecting for the skip connection may include, in response to a determination that the neural network is configured to use the first data in the second layer after the first data may be output by the first layer, detecting for the skip connection between the first layer and the second layer based on a determined hierarchical distance between the first layer and the second layer.

With the neural network including the skip connection, the generating of the compiled version of the neural network may further include determining whether to change the skip connection based on a result of a comparing of a computational load of a copied layer set, which may be a copy of the determined decompression layer set, with a threshold computation overhead.

With the neural network including the skip connection, the generating of the compiled version of the neural network may further include determining whether to change the skip connection based on a result of a comparing of memory usage of a copied layer set, which may be a copy of the determined decompression layer set, with a threshold memory overhead.

In one general aspect, one or more embodiments may include a non-transitory computer-readable storage medium storing code that, in response to being executed by one or more processors, cause the one or more processors to perform any one, any combination, or all operations described herein.

In one general aspect, processor-implemented method includes detecting for an activation layer set in a neural network, the activation layer set including a decompression layer that is configured to decompresses input data, an activation layer that is configured to apply an activation function to an output of the decompression layer, and a compression layer that is configured to compress data that is based on an output of the activation layer, and generating a compiled version of the neural network by changing the activation layer set into a fusion layer that is configured to perform decompression, application of an activation function, and compression for each of tiles that may be dependent of the input data.

The detecting for the activation layer set may include detecting for the decompression layer, the activation layer, a pooling layer that that may be configured to apply a pooling to the output of the activation layer, and the compression layer that may be configured to compresses an output of the pooling layer, and the fusion layer may be further configured to perform an application of pooling.

The detecting for the activation layer set may include detecting for a concatenation layer set including a first decompression layer, a first activation layer that may be configured to apply a first activation function to an output of the first decompression layer, a second decompression layer, a second activation layer that may be configured to apply a second activation function to an output of the second decompression layer, a first concatenation layer that may be configured to concatenate an output of the first activation layer and an output of the second activation layer, and the compression layer that may be configured to compress an output of the first concatenation layer in the neural network, and the changing of the activation layer set may include changing the concatenation layer set into the fusion layer.

The detecting for the activation layer set may further include detecting for a concatenation layer set including a first decompression layer, a first activation layer that may be configured to apply a first activation function to an output of the first decompression layer, a second decompression layer, a second activation layer that configured to apply a second activation function to an output of the second decompression layer, a first concatenation layer that may be configured to concatenate an output of the first activation layer and an output of the second activation layer, and the compression layer that may be configured to compress data that may be based on an output of the first concatenation layer in the neural network, and the changing of the activation layer set may include, in response to a determination that the first activation function may be same as the second activation function, replacing the concatenation layer set with a second concatenation layer that may be configured to concatenate an input of the first decompression layer and an input of the second decompression layer, and the fusion layer that may be configured to perform an application of the first activation function as the application of the activation function, and the compression for each of the tiles that may be extracted from an output of the second concatenation layer.

The detecting for the activation layer set may further include detecting for a concatenation layer set including a first decompression layer, a first activation layer that may be configured to apply a first activation function to an output of the first decompression layer, a second decompression layer, a second activation layer that configured to apply a second activation function to an output of the second decompression layer, a first concatenation layer that may be configured to concatenate an output of the first activation layer and an output of the second activation layer, and the compression layer that may be configured to compress data that may be based on an output of the first concatenation layer in the neural network, and the changing of the activation layer set may include, in response to a determination that the first activation function may be different from the second activation function, replacing the concatenation layer set with a first fusion layer that may be configured to perform decompression, application of the first activation function, and compression for each of tiles for an input of the first decompression layer, a second fusion layer that may be configured to perform decompression, application of the second activation function, and compression for each of tiles for an input of the second decompression layer, and a summation layer that may be configured to sum an output of the first fusion layer and an output of the second fusion layer.

The generating of the compiled version of the neural network may further include changing a detected skip connection, based on a determined decompression layer set, before the changing of the activation layer set.

In one general aspect, an electronic device includes one or more processors, and a memory storing code, wherein the code is configured to, in response to being executed by the one or more processors, cause the one or more processors to detect for a skip connection in a neural network, where the skip connection is configured to output first data to a second layer in the neural network, wherein the first data is output from a first layer in the neural network, and wherein the second layer is beyond a hierarchically subsequent layer of the first layer in the neural network, determine, in the neural network, a decompression layer set including a layer, which is configured in the neural network to be input second data with a dimension smaller a dimension of the first data, that is among one or more layers hierarchically preceding the first layer in the neural network, and generate a compiled version of the neural network by changing the skip connection dependent on the determined decompression layer set.

For the changing of the skip connection, the instructions may be configured to, in response to being executed by the processor, cause the one or more processors to change the detected skip connection, from the output of the first data from the first layer to the second layer, into a different skip connection using a copied layer set, which may be a copy of the determined decompression layer set, that may be configured to be input the second data and provide third data output from the copied layer set to the second layer.

The code may be configured to, in response to being executed by the one or more processors, cause the one or more processors to detect, in the neural network, for an activation layer set including a decompression layer that may be configured to decompresses the second data, an activation layer that may be configured to apply an activation function to an output of the decompression layer, and a compression layer that may be configured to compresses an output of the activation layer in the neural network, wherein the generation of the compiled version of the neural network may further include a changing of the detected activation layer set into a fusion layer that may be configured in the compiled version of the neural network to perform decompression, application of an activation function, and compression for each of tiles extracted from the second data.

Other features and aspects will be apparent from the following detailed description, the drawings, and the claims.

### BRIEF DESCRIPTION OF THE DRAWINGS

FIG. 1 illustrates an example of a deep learning compilation method of compiling a neural network by an electronic device according to one or more embodiments.

FIG. 2 illustrates an example of a deep learning compilation method of compiling a neural network based on a skip connection by an electronic device according to one or more embodiments.

FIG. 3 illustrates an example of a neural network compilation operation of changing at least a portion of a skip connection by an electronic device according to one or more embodiments.

FIG. 4 illustrates an example of a deep learning compilation method of compiling a neural network based on an activation layer set by an electronic device according to one or more embodiments.

FIG. 5 illustrates an example of a neural network compilation operation of changing an activation layer set into a fusion layer by an electronic device according to one or more embodiments.

FIG. 6 illustrates an example of a neural network compilation operation of changing a detected activation layer set after changing a skip connection by an electronic device according to one or more embodiments.

FIG. 7 illustrates an example of a neural network compilation operation of changing a concatenation layer set into a fusion layer by an electronic device when a first activation function is the same as a second activation function according to one or more embodiments.

FIG. 8 illustrates an example of a concatenation layer set and a temporary activation layer set according to one or more embodiments.

FIG. 9 illustrates an example of a neural network compilation operation of changing a concatenation layer set into a fusion layer by an electronic device when a first activation function is different from a second activation function according to one or more embodiments.

FIG. 10 illustrates an example of a concatenation layer set, a first temporary activation layer set, and a second temporary activation layer set according to one or more embodiments.

FIG. 11 illustrates an example of an electronic device according to one or more embodiments.

Throughout the drawings and the detailed description, unless otherwise described or provided, the same drawing reference numerals may be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment”, and “one or more examples” has a same meaning as “in one or more embodiments”).

Throughout the specification, when a component or element is described as being “on”, “connected to,” “coupled to,” or “joined to” another component, element, or layer it may be directly (e.g., in contact with the other component, element, or layer) “on”, “connected to,” “coupled to,” or “joined to” the other component, element, or layer or there may reasonably be one or more other components, elements, layers intervening therebetween. When a component, element, or layer is described as being “directly on”, “directly connected to,” “directly coupled to,” or “directly joined” to another component, element, or layer there can be no other components, elements, or layers intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

Unless otherwise defined, all terms, including technical and scientific terms, used herein have the same meaning as commonly understood by one of ordinary skill in the art to which this disclosure pertains and specifically in the context on an understanding of the disclosure of the present application. Terms, such as those defined in commonly used dictionaries, are to be interpreted as having a meaning that is consistent with their meaning in the context of the relevant art and specifically in the context of the disclosure of the present application, and are not to be interpreted in an idealized or overly formal sense unless expressly so defined herein.

As a non-limiting example, compiler optimization may optimize the efficiency of machine code that is output from a compiler. Such optimization may be used to slow down execution of instructions (e.g., a program or code, as non-limiting examples) or reduce or minimize the amount of memory used while instructions are executed, noting that alternative or additional examples are also available.

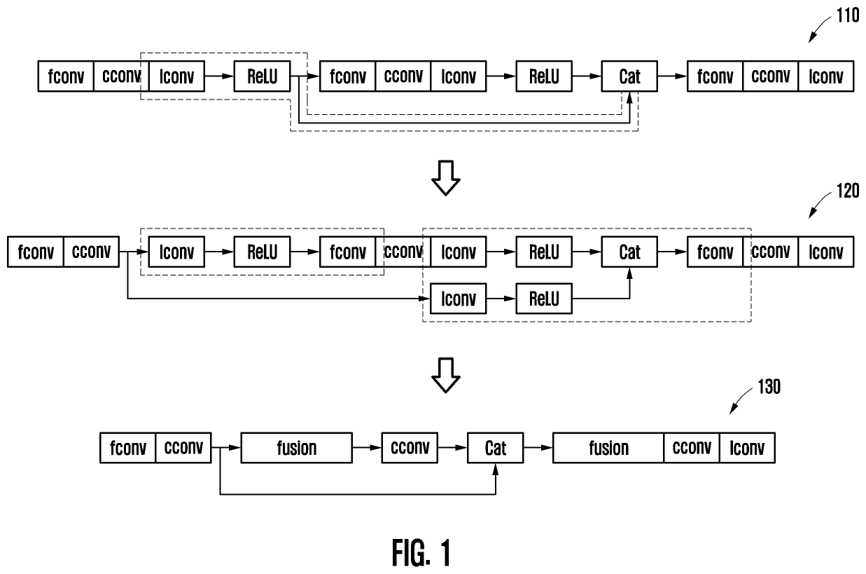

FIG. 1 illustrates an example of a deep learning compilation method of compiling a neural network by an electronic device according to one or more embodiments.

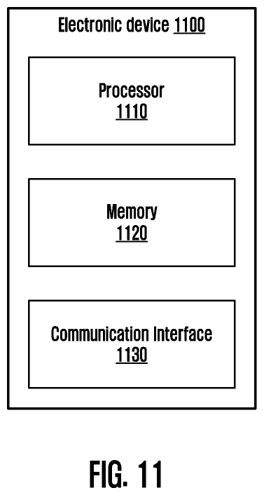

One or more processors of an electronic device according to an example may perform neural network compilation operations on a neural network to generate instructions (e.g., code) for performing an inference operation of the neural network through the one or more processors and/or other one or more processors executing such generated instructions. The other one or more processors may be comprised in the electronic device or another electronic device (e.g., where such electronic devices could each correspond to the electronic device 1100 of FIG. 11, and the processor 1110 may represent the one or more processors, as well as the other one or more processors, though embodiments are not limited thereto). Below, merely for expedience of explanation, explanations of embodiments may be presented through reference to operations performed by the electronic device, meaning that one or more processors of the electronic device are configured to perform the same operations. Likewise, explanations of examples by reference to operations performed by the electronic device are also intended to apply to the other one or more processors of the electronic device and/or of the other electronic device. For example, while neural network compilation operations of an optimization of a neural network for the generation of compiled instructions, the generation of compiled instructions, and/or optimization of such compiling instructions may correspond to a reduction of computational load or improvement (e.g., reduction of) memory usage, as a non-limiting example technological improvements, respectively with respect to the one or more processors and one or more memories of the electronic device if/when the one or more processors would execute the compiled instructions or optimized compiled instructions compared to an execution of typical (without optimization) compiled instructions of the original (unoptimized) neural network. Such optimizations may also and/or alternatively correspond to a reduction of computational load and/or improvements in memory usage respectively on the other one or more processors or one or more memories of the electronic device and/or the other electronic device that execute the compiled instructions or optimized compiled instructions. In addition, explanations of examples by reference to operations performed by any electronic device are also intended to cover execution of corresponding code by the one or more processors (or the other one or more processors) of the electronic device (or other electronic device) that thereby causes or configures the one or more processors (or the other one or more processors) to perform the operations.

A neural network is a type of machine learning model and may include a deep learning model that includes a plurality of layers. The plurality of layers may include an input layer, one or more hidden layers, and an output layer. There may be multiple input layers, multiple output layers, and various parallel hidden layers. In various examples herein, a neural network may include a convolutional neural network including one or more convolutional layers, though embodiments are not limited thereto.

Each corresponding layer of a neural network may apply a respective operation (e.g., any of pooling, unpooling, summation, subtraction, convolution, deconvolution, concatenation, or deconcatenation, as non-limiting examples) of the corresponding layer to a respective input (or input data) to that corresponding layer, for example, for generating a corresponding output (output data) of that corresponding layer. In addition, while some layers herein may be described as performing an operation, a layer may perform multiple operations, such as with respect to the fusion layers described further below.

Compared to a typical compiler that may convert source code written in a programming language into object or machine code, neural network compiling (e.g., deep learning compilation) a neural network may include optimizing a neural network for the generation of instructions for performing the operations indicated by layers of the neural network, the generation of the instructions based on the optimized neural network, and/or optimization of instructions resulting from a compiling of the original neural network or further optimization of the instructions resulting from the compiling of the optimized neural network. Further, herein, a compiled neural network may be the result the performance of at least one of such neural network compilation operations with respect to a neural network, which may be an entire neural network or a portion of a larger neural network. Thus, the compiled neural network may represent a compiled version of the neural network, as the optimized neural network, the generated instructions of the optimized neural network, and/or the optimized compiled instructions of the neural network. The performance of such neural network compilation operations may further include performing the generating of first instructions for first portions of an original neural network and generating second instructions of an optimized neural network (resulting from performance of such optimizations of another portion of the original neural network), or generating of third instructions for all portions of the original neural network optimization and performing optimization of some of those third instructions corresponding to one or more portions of the original neural network, as non-limiting examples. In addition, while references may be made to a neural network or an original neural network, the referenced neural network or original neural network may also be a portion of a larger neural network.

The electronic device may include one or more memories that store a neural network, such as through the storing of respective parameters of the neural network, or otherwise obtain the neural network to which optimization (e.g., of a computational load) may applied, for example. As a non-limiting example, the one or memories may be represented by the memory 1120 of FIG. 11. As an example neural network compilation operation, the electronic device may perform an optimization of the computational load, which may include reducing a computational load on the one or more processors of the electronic device by changing and/or approximating at least a portion of the operation of each of one or more layers of a neural network. For example, optimization of the computational load may include the performance of convolution decomposition applicable to a convolutional layer. For example, convolution decomposition may include dividing an original convolutional layer (i.e., before optimization) into a plurality of convolutional layers (e.g., a plurality of sub-convolutional layers). The convolution decomposition may reduce the computational load of the neural network by using the fact that a total of the respective computational loads of the plurality of sub-convolutional layers can be less than a computational load of the original convolutional layer. As a non-limiting example, neural network 110 of FIG. 1 may represent the result of such a convolution decomposition operation.

According to an example, examples of these sub-convolutional layers may include a compression convolutional layer (hereinafter, also referred to as a “compression layer”) (e.g., respective fconv layers of FIG. 1) that reduces a dimension of an input, a core convolutional layer (hereinafter, also referred to as a “core layer”) (e.g., respective cconv layers of FIG. 1) that is applied to an output of a compression convolutional layer, and a decompression convolutional layer (hereinafter, also referred to as a “decompression layer”) (e.g., respective Iconv layers of FIG. 1) that increases a dimension of an output of a core convolutional layer. For example, in the upper most illustration of FIG. 1, with respect to neural network 110, the left most sequence of sub-convolutional layers fconv, cconv, and Iconv may result from the aforementioned optimization operations of convolution decomposition of a first convolutional layer of the original neural network. The next sequence of sub-convolutional layers fconv, cconv, and Iconv in neural network 110 may result from the aforementioned optimization operations of convolution decomposition of a next convolutional layer in the original neural network. Said another way, for each of multiple original convolutional layers a different group of sub-convolutional layers fconv, cconv, and Iconv may be generated. As an example, while the first convolutional layer of the original neural network corresponds to a convolution operation applied to an input with an original dimension, the first sub-convolutional layers correspond to a convolution operation corresponding to a core layer applied to data with a reduced dimension, and therefore, the computational load of the neural network may be reduced through the convolution decomposition. Convolution decomposition may include approximation. Each of the first and second convolutional layers may have been immediately followed by an activation operation layer where corresponding activation functions are respectively applied to results of the first and second convolutional layers. The corresponding activation layers are represented in neural networks 110 and 120 of FIG. 1 as ReLU activation layers, as non-limiting examples.

As an example neural network compilation operation, the electronic device may control (e.g., improve) memory usage by changing at least a portion of a neural network to which optimization of the computational load may have been applied. As a non-limiting example, electronic device may reduce maximum usage (e.g., a memory peak) of a memory (e.g., a global memory) that would be used while executing the instructions of the resultant compiled (through the example memory usage changes) neural network for an inference operation of the neural network compared to an inference operation of the original neural network (or the inference operation of neural network 110, for example).

For example, referring to FIG. 1, the electronic device may detect the illustrated skip connection in the neural network 110. A skip connection may refer to an output of a specific layer being input to another layer beyond a hierarchically immediate subsequent layer of the specific layer. The skip connection may further refer to an example where a hierarchical distance between the specific layer and the other layer is greater than a threshold distance of one or more layers. When the size (e.g. a dimension) of data transmitted from the specific layer to the other layer through the skip connection is large, maximum usage of a memory may increase. When a detection for a skip connection occurs, such as when the size of the data that would be transmitted through the skip connection would be large, the electronic device may reduce the maximum usage of a memory by changing a neural network to transmit reduced data than data that would have been transmitted through the skip connection of the original neural network (or an optimized neural network resulting from the convolution decomposition). With respect to neural network 110, when the result of the detection for the skip connection is that the skip connection is detected, neural network 110 may be changed (to generate neural network 120, for example) to reduce memory in the execution of the skip connection in neural network 120 compared to memory usage in the execution of the skip connection in neural network 110, for example.

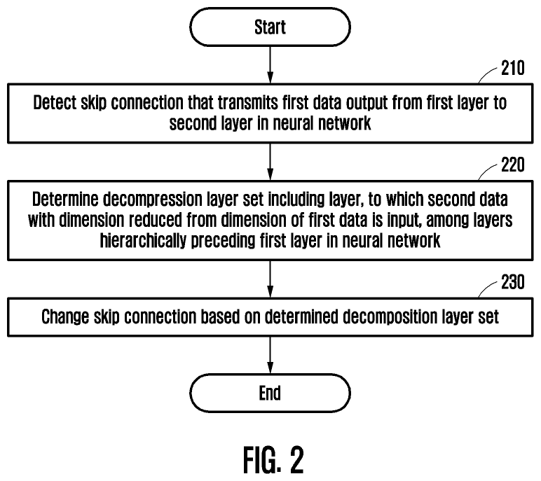

Accordingly, as demonstrated in the resultant neural network 120, the electronic device changes the detected skip connection based on some layers of the neural network 110. As will be described below with reference to various neural network compilation operations respectively described with respect to FIGS. 2 to 11, a maximum usage of the memory may be reduced by variously changing respective skip connections.

As an example neural network compilation operation, the electronic device may change a group of layers into a fusion layer. For example, in generating neural network 130, a first group of layers (also referred to as a first activation layer set) including a first decompression layer (e.g., the left most illustrated Iconv of neural network 120 of FIG. 1), a first activation layer (e.g., the left most illustrated ReLU of neural network 120 of FIG. 1), and a first compression layer (e.g., the centrally illustrated fconv of neural network 120 of FIG. 1) may be changed into a first fusion layer (e.g., the left most illustrated fusion layer of neural network 130 of FIG. 1). As another example, a second group of layers (also referred to as a second activation layer set) including two second decompression layers (e.g., the centrally illustrated two Iconv layers of neural network 120 of FIG. 1), second activation layers (e.g., the remaining illustrated ReLU layers of neural network 120 of FIG. 1), and a second compression layer (e.g., the right most illustrated fconv of neural network 120 of FIG. 1) may be changed into a second fusion layer (e.g., the right most illustrated fusion of neural network 130 of FIG. 1). Thus, in generating neural network 130, the electronic device may change a layer sequence (also expressed as an activation layer set in various examples herein) including a decompression layer, an activation layer, and a compression layer into a fusion layer. As will be described below with reference to various neural network compilation operations respectively described with respect to FIGS. 2 to 11, respective maximum usages of one or more memories may be reduced by changing such activation layer sets.

While examples are not limited thereto, as such neural network compilation operations may be performed on layers that do result from a convolution decomposition operation, the neural network compilation operations described with respect to FIGS. 1 to 10 are explained from the perspective of such a convolution decomposition having already been performed to the underlying original neural network. For example, various example neural network compilation operations may be applied to a neural network that includes one or more layers corresponding to convolution decomposition of at least one corresponding layer of an original neural network having already been performed, such as in which at least a specific layer of an original neural network has previously been converted (through the aforementioned convolution decomposition) into a compression layer that reduces a dimension of input data, a core layer that applies an operation to an output of a compression layer with a reduced dimension, and a decompression layer that increases a dimension of an output of a core layer. Neural network 110 of FIG. 1 demonstrates an example neural network having layers corresponding to the convolution decomposition of an original neural network having already been performed. Thus, neural network compilation operations may be performed with respect to at least one of the layers corresponding to the convolution decomposition. Said another way, in the below examples of FIGS. 2 to 10 references to an original neural network, on which example neural network compilation operations are to be performed, is meant to refer to a neural network on which at least convolution decomposition of at least one convolutional layer has been performed.

FIG. 2 illustrates an example of a deep learning compilation method of compiling a neural network based on a skip connection by an electronic device according to one or more embodiments.

In operation 210, the electronic device may detect for a skip connection that transmits first data output from a first layer to a second layer in a neural network. The second layer may be beyond a hierarchically subsequent layer of the first layer in the neural network, i.e., not the hierarchically immediate subsequent layer to the first layer in the neural network. In various examples, data input to and/or output from a layer of a neural network may also be expressed as a tensor, a feature, and/or a feature map.

While the first data may be input to and used in an immediately sequentially subsequent layer with respect to the first layer, the electronic device may also detect for (or have detected) a skip connection between the first layer and the second layer based on a hierarchical distance between the first layer and the second layer, and the first data may also be input and used by the second layer. The hierarchical distance between the first layer and the second layer may be determined based on the number of layers positioned between the first layer and the second layer. When the hierarchical distance between the first layer and the second layer is greater than or equal to a threshold distance, e.g., at least one layer, the electronic device may detect the skip connection between the first layer and the second layer.

A determination of the first data by the first layer refers to the first data being determined due to it being output from the first layer, or may refer to the operation of and/or a result of the applying of an operation corresponding to the first layer within/by the first layer to the input of the first layer. The first data input to the second layer may also be referred to as input data to the second layer, and thus use of the first data by the second layer may also be called a use of the input data to the second layer by the second layer, where such use within the second layer may refer to that an operation corresponding to the second layer being applied to the first data (or input data to the second layer). In addition, the second layer may also receive an output (which may also be referred to as another input) from an immediately sequentially previous layer with respect to the second layer. For example, the second layer could receive plural inputs, from at least the first layer and the immediately sequentially previous layer, and the second layer may perform the operation corresponding to the second layer to the plural inputs.

In various examples, the determination of the first data in the first layer may also be expressed as defining the first data.

According to an example, the electronic device may detect for a skip connection based on a dimension of the first data. For example, when the dimension of the first data is less than or equal to a reference dimension (e.g., indicating that the first data is reduced data (or compressed data)), while a skip connection may exist for transmitting the first data from the first layer to the second layer, the skip connection may not be detected. As an example, when the dimension of the first data is greater than the reference dimension (e.g., when the first data is decompressed data), the skip connection that transmits the first data may be detected. As described above with reference to FIG. 1, when the dimension of data (e.g., the first data) transmitted through the skip connection is great, the maximum usage of the memory may increase. Therefore, when a skip connection that would have transmitted data exceeding the reference dimension is detected, the electronic device may reduce the maximum usage of the memory by performing operations 220 and 230 described below.

In operation 220, the electronic device may determine a decompression layer set. The decompression layer set may include a layer, to which second data (with a dimension smaller than a dimension of the first data) is input, among layers hierarchically preceding the first layer in the neural network. As an example, the decompression layer set may include one layer or two or more layers, with one of the layers outputting the first data by decompressing second data, with the smaller or reduced dimension, generated by the corresponding preceding layer. As a non-limiting example, the second data may have the smaller dimension due to the aforementioned convolution decomposition having been performed on a convolution layer, for example, of a corresponding neural network, resulting in a compression layer, a core convolutional layer, and a decompression layer in the current neural network, where the first data may have been generated by this resultant decompression layer (as well as the corresponding convolution layer) and the second data may be generated by the core convolution layer based on data that was compressed by the compression layer. Thus, the second data can also be referred to having a dimension reduced from a dimension of the first data. When convolution decomposition is performed as one of the neural network compilation operations, it may also be detectable or known by the electronic device which preceding data was reduced from a dimension of the corresponding convolution layer of the corresponding neural network, and that preceding data may be detected as having a dimension reduced from the dimension of the first data.

For example, the electronic device may sequentially search for layers (e.g., including one or more of sub-convolutional layers resulting from convolution decomposition of a corresponding neural network) hierarchically preceding the first layer, in order of proximity to the first layer. The electronic device may detect the decompression layer among the layers preceding the first layer. The electronic device may determine the layers from the decompression layer to the first layer as a decompression layer set.

For example, the electronic device may determine the decompression layer based on a dimension of input data of each of the preceding layers. The electronic device may detect a decompression layer, to which second data (with a dimension smaller than or reduced from the dimension of the first data by more than a threshold dimension) is input, among the preceding layers preceding the first layer. As noted above, in an example, the second data could be generated/output of an immediately preceding convolutional core layer. When the first data is M-dimensional and the reference dimension is N-dimensional, the electronic device may detect a decompression layer, to which data with a dimension less than M-N dimension is input, among the layers hierarchically preceding the first layer.

For example, the electronic device may determine the decompression layer based on predetermined information about each layer of the neural network. The electronic device may obtain information about each layer of the neural network. Information about each layer may include a description of an operation corresponding to a corresponding layer. Herein, such information about each layer may be included in hyperparameters of a corresponding neural network before the convolution decomposition was performed on the corresponding neural network), may be stored in the memory of the electronic device as a hyperparameter of the neural network, or may be otherwise indicated in programming code defining the neural network or the corresponding neural network. The electronic device may detect the decompression layer that decompresses input data among the preceding layers using the information about each layer.

In operation 230, the electronic device may change the skip connection based on the determined decompression layer set.

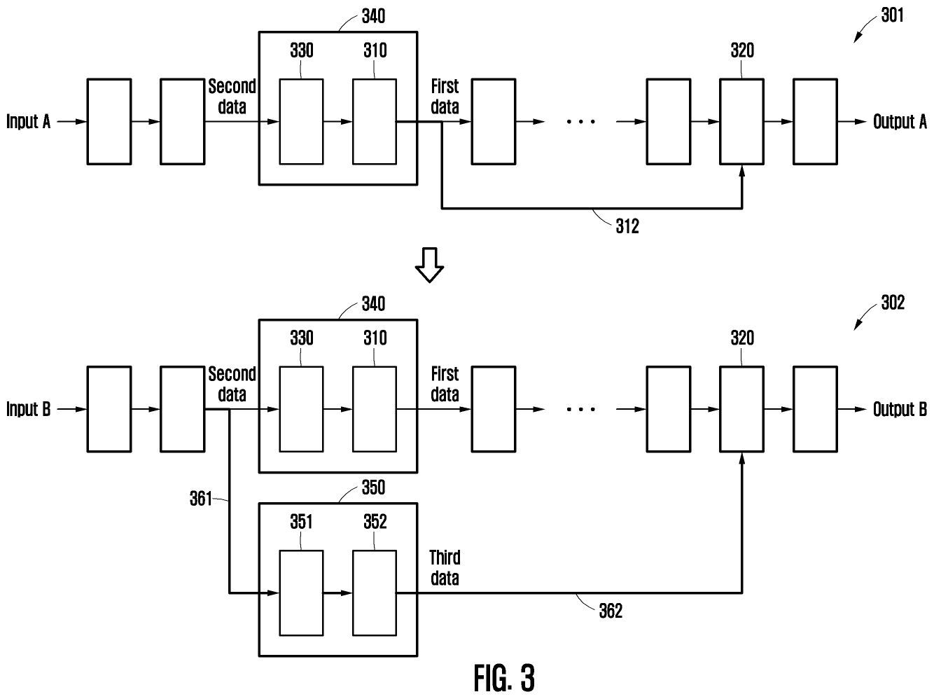

According to an example, as a neural network compilation operation, the electronic device may change the detected skip connection by inputting the second data to a copied layer set that is a copy of the determined decompression layer set, and transmitting third data output from the copied layer set to the second layer. The compiled neural network may include the resultant layers with respect to the changed skip connection as well as other layers (other than those involved with the changed skip connection) that were not changed. The copied layer set is a copy of the decompression layer and may be configured to perform the same operation as the operation of the decompression layer. As will be described in more detail with reference to FIG. 3, when the decompression layer set includes a plurality of layers, the copied layer set may also include a plurality of layers that respectively perform the same operations as the plurality of layer of the decompression layer set.

The third data may refer to a result of applying the copied layer set to the second data. The first data may include a result of applying the decompression layer set to the second data before the changing of the detected skip connection, and the third data may have the same value as the first data. As a result, comparing the neural network that had the skip connection that transmits the first data from the first layer to the second layer and the resultant compiled neural network with the changed skip connection that transmits the third data to the second layer, the third data has the same value as the first data, resulting in the compiled neural network outputting the same operation result despite the change of the skip connection.

According to an example, the electronic device may determine whether to change the skip connection based on the copied layer set, based on a computational load and/or memory usage.

In an example, the electronic device may determine whether to change the skip connection based on a result of comparing a computational load of a copied layer set that is a copy of a decompression layer set with threshold computation overhead. In an example, the copied layer set may be the copied layer set determined based on the result of the above detecting for the skip connection. The electronic device may determine the floating point operations (FLOP) of the copied layer set. FLOP may refer to an indicator of the amount of floating point operations performed per second. When the computational load of the copied layer set (e.g., the additional computational load due to the addition of the copied layer set) is greater than threshold computation overhead, the electronic device may determine not to change the skip connection based on the copied layer set. For example, in the above example when a result of the detection for the skip connection results in the detection of the skip connection, even though the skip detection is detected the skip connection may not be changed and the skip connection may be maintained, such as in any resultant compiled neural network (e.g., if other neural network compilation operations are performed with respect to the neural network). When the computational load of the copied layer set is less than or equal to the threshold computation overhead, the electronic device may determine to change the skip connection based on the copied layer set.

In an example, the electronic device may determine whether to change the skip connection based on a result of comparing memory usage of the copied layer set that is a copy of the determined decompression layer set with threshold memory overhead. When the memory usage of the copied layer set (e.g., the additional memory usage due to the addition of the copied layer set) is greater than the threshold memory overhead, the electronic device may determine to not to change the skip connection based on the copied layer set. For example, in the above example when a result of the detection for the skip connection results in the detection of the skip connection, even though the skip detection is detected the skip connection may not be changed and the skip connection may be maintained, such as in any resultant compiled neural network (e.g., if other neural network operations are performed with respect to the neural network). When the memory usage of the copied layer set is less than or equal to the threshold memory overhead, the electronic device may determine to change the skip connection based on the copied layer set.

In an example, the electronic device may determine whether to change the skip connection based on the computational load and the memory usage of the copied layer set. When the computational load of the copied layer set is less than or equal to the threshold computation overhead and the memory usage of the copied layer set is less than or equal to the threshold memory overhead, the electronic device may determine to change the skip connection based on the copied layer set. When the computational load of the copied layer set is greater than the threshold computation overhead or the memory usage of the copied layer set is greater than the threshold memory overhead, the electronic device may determine not to change the skip connection based on the copied layer set.

FIG. 3 illustrates an example of a neural network compilation operation of changing at least a portion of a skip connection by an electronic device according to one or more embodiments.

Referring to FIG. 3, each illustrated block may represent a layer of a corresponding neural network. As a non-limiting example, a neural network 301 and a neural network 302 of FIG. 3 correspond to at least a portion of an original neural network. For example, the neural network 301 may be a portion of the original neural network, and the neural network 302 may correspond to a result or interim result of a neural network compilation operation performed on the neural network 301.

An electronic device may detect a skip connection 312 in neural network 301 between a first layer 310 and a second layer 320. The electronic device may detect a decompression layer 330, to which second data with a dimension smaller than a dimension of first data is input, among layers hierarchically preceding the first layer 310.

The electronic device may determine layers from the decompression layer 330 to the first layer 310 as a decompression layer set 340. FIG. 3 shows that there are no layers between the decompression layer 330 and the first layer 310, however examples are not limited thereto. For example, the decompression layer set 340 is also representative of there being one or more additional intermediate layers between the decompression layer 330 and the first layer 310, and the electronic device may determine the decompression layer set 340 including the decompression layer 330, the one or more intermediate layers, and the first layer 310.

The electronic device may change the skip connection 312 based on the decompression layer set 340. The electronic device may replace the skip connection 312 that transmits the first data output from the first layer 310 to the second layer 320 with operation 361 of inputting the second data to a copied layer set 350 and operation 362 of transmitting third data output from the copied layer set 350 to the second layer 320. As described above, the copied layer set 350 is a copy of the decompression layer set 340, and may include, for example, in FIG. 3, a copy 351 of the decompression layer 330 and a copy 352 of the first layer 310. The third data may have the same value as the first data. The electronic device may obtain the neural network 302 by changing at least a portion of the skip connection 312 in the neural network 301.

In the neural network 302, which may also be referred to as a compiled neural network 302, the electronic device may reduce maximum usage of a memory without changing an operation result by maintaining a value of an input of the second layer 320 even when the skip connection 312 is changed to the copied layer set 350. For example, when an input A and an input B have the same value, an output A obtained by applying the input A to the neural network 301 may have the same value as an output B obtained by applying the input B to the neural network 302.

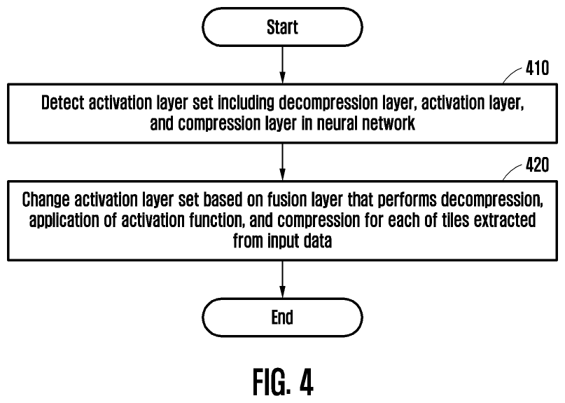

FIG. 4 illustrates an example of a deep learning compilation method of compiling a neural network based on an activation layer set by an electronic device according to one or more embodiments.

In operation 410, an electronic device may detect (or detect for) an activation layer set including a decompression layer that decompresses input data, an activation layer that applies an activation function to an output of the decompression layer, and a compression layer that compresses an output of the activation layer in a neural network. The decompression and compression layers may be sub-convolutional layers as discussed above with respect to FIG. 1, for example.

The activation layer set may refer to a plurality of layers including a decompression layer before an activation layer, the activation layer, and a compression layer after the activation layer. The electronic device may detect a layer (e.g., the decompression layer, the activation layer, or the compression layer) of the activation layer set based on information about each layer of the neural network (e.g., predetermined information, such as included in hyperparameters of the neural network, included in programming code defining the neural network, or otherwise determined) or may detect a layer of the activation layer set based on respective dimensions of input data and/or respective dimensions of output data of each of plural layers in the neural network.

In operation 420, the electronic device may change the activation layer set into a fusion layer that performs decompression, application of an activation function, and compression for each of tiles extracted from input data. The resultant neural network with the fusion layer instead of the activation layer set may be referred to as a compiled neural network.

As described above, the decompression and/or compression of the input data performed by the decompression layer and/or the compression layer may be respectively performed through convolution operations of the respective layers. As a non-limiting example, a convolution operation may include calculating a convolution (e.g., summation of element-wise multiplications) between a filter (or kernel) and input data while moving the filter according to a set stride. The stride may refer to the amount of each movement of the filter through the input data. The input data may be divided into a plurality of tiles based on the filter and the stride, and one tile may determine one element of an output of a convolution operation through a convolution with the filter. The filter may be multi-dimensional. For example, the filter may include at least two dimensions (or channels) when the input includes at least two channels, and at least three dimensions (or channels) when the input includes at least three channels. In an example, the filter may include three dimensions when the input includes two channels, and four dimensions when the input includes three channels.

The electronic device may change the activation layer set into a fusion layer that performs decompression, application of an activation function, and compression for each of tiles of input data. The tiles of the input data may be extracted based on the filter and/or a stride along the decompression layer to which the input data is applied.

According to an example, the activation layer set may further include a pooling layer. For example, the electronic device may detect (or detect for) an activation layer set including a decompression layer, an activation layer, a pooling layer that applies pooling to an output of the activation layer, and a compression layer that compresses an output of the pooling layer. The electronic device may change the activation layer set into a fusion layer that performs decompression, application of an activation function, application of pooling, and compression for each of tiles extracted from the input data.

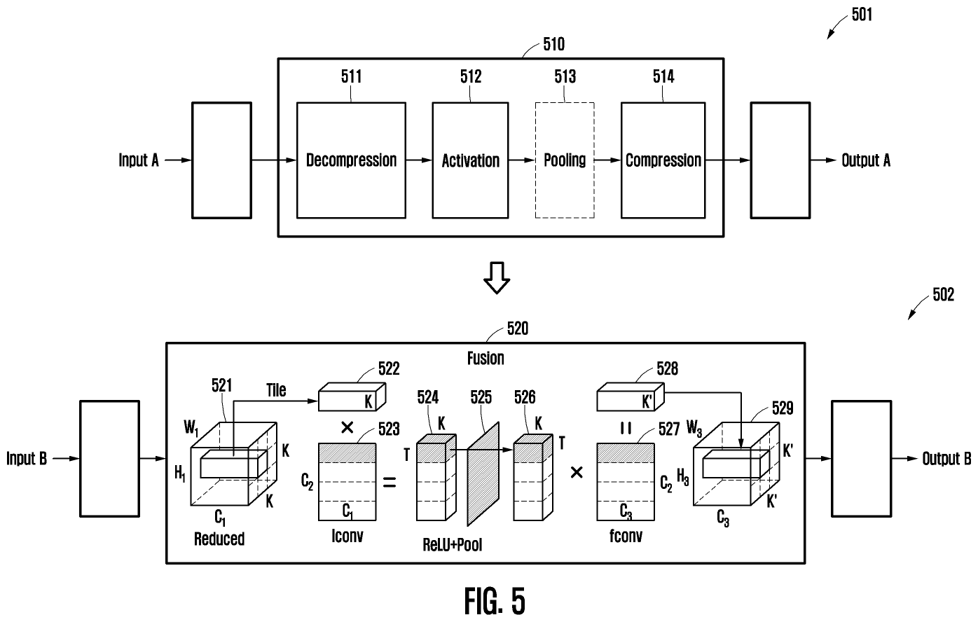

An example of the operation of changing the activation layer set into a fusion layer will be described below in more detail with reference to FIG. 5.

According to an example, the electronic device may reduce maximum usage of a memory required for an inference operation of a neural network by compiling the neural network, including changing the activation layer set into a fusion layer.

As a non-limiting example, neural network compilation operations may include a compiling of a neural network that includes the electronic device generating instructions that instruct, for each layer, the reading of an input and/or weights of an operation corresponding to a corresponding layer from a global memory, the performing of an operation using the obtained input and/or weights using one or more processors of the electronic device, and the writing of the result of the performed operation on the global memory. The electronic device may replace (or perform instead) at least a portion of the operation of reading from the global memory and/or the operation of writing on the global memory with other operations (e.g., reading from and/or writing on a local memory) to optimize a computational load and/or time during the process of neural network compiling the neural network through any one, any combination, or all of the neural network compilation operations described with respect to FIGS. 1-10.

The implementation or execution of layers corresponding to an activation layer set of a neural network may include operations of storing and/or reading an input and/or an output of the such operation by accessing a global memory each time the execution of an operation corresponding to each of the decompression layer, the activation layer, and the compression layer included in the activation layer set starts and ends. At this time, the global memory is likely to store, in particular, an output of the decompression layer (i.e., an input of the activation layer) and an input of the compression layer (i.e., an output of the activation layer), and since the output of the decompression layer and/or the input of the compression layer may have a larger dimension than that of an input of the decompression layer and/or an output of the compression layer, the maximum usage of the global memory may increase. Thus, when neural network compiling is performed, and instructions corresponding to the layers corresponding to the activation layer set are generated, when the generated instructions are executed the maximum usage of the global memory may increase or be unnecessarily large.

On the other hand, when the layers corresponding to the activation layer set are changed to a single fusion layer as an example neural network compilation operation, the generated instructions for the single fusion layer may only instruct reads or stores of an input of the fusion layer (e.g., the same as the input of the decompression layer) and an output of the fusion layer (e.g., the same as the output of the compression layer) from or in the global memory, and therefore, when the instructions with the fusion layer are generated and executed the corresponding operations may be performed with smaller usage of the global memory than is required by the generated instructions for the layers corresponding to the activation layer set. Herein, a compiled neural network according to one or more embodiments may include code (e.g., programming code) or other information identifying plural layers of the neural network with the changed layers, or may include such generated instructions (e.g., machine code, object code, or other code executable by the one or more processors) that control, for each of plural layers including the changed layers, the reading of an input and/or weights of an operation corresponding to a corresponding layer from a memory (e.g., global and/or local), the performing of an operation of the corresponding layer using the obtained input and/or weights using one or more processors of the electronic device, and the writing of the result of the performed operation on the memory. In an example, the detection for any of the skip connections, decompression layer sets, activation layer sets, etc., and/or such determinations of whether to change skip connections (or other determinations or detections described herein) and corresponding analyses such determinations are based on, may be performed during the generating of the instructions as neural network compilation operations of the compiling of the neural network. In addition, in an example, convolution decompositions discussed above may also be performed during the generating of the instructions as a neural network compilation operation.

FIG. 5 illustrates an example of a neural network compilation operation of changing an activation layer set into a fusion layer by an electronic device according to one or more embodiments.

Referring to FIG. 5, each illustrated block may represent a layer of a corresponding neural network. As a non-limiting example, a neural network 501 and a neural network 502 of FIG. 5 correspond to at least a portion of a neural network. For example, the neural network 501 may be a portion of the neural network, and the neural network 502 may correspond to a result of a neural network compilation operation performed on the neural network 501.

In the neural network 501, the electronic device may detect (or detect for) an activation layer set 510 including a decompression layer 511, an activation layer 512, and a compression layer 514. For example, the activation layer set 510 may correspond to the activation layer set described above with respect to FIG. 4. In an example, the activation layer set 510 may further includes the pooling layer 513.

In the neural network 502, the electronic device may change the activation layer set 510 into a fusion layer 520. The fusion layer 520 may be configured to perform decompression, application of an activation function, application of pooling, and compression for each of a plurality of tiles extracted from input data 521 of the decompression layer 511. The decompression performed in the fusion layer 520 may be performed based on a filter of the decompression layer 511. The application of an activation function performed in the fusion layer 520 may be performed based on an activation function of the activation layer 512. The application of pooling performed in the fusion layer 520 may be performed based on pooling performed in the pooling layer 513. The compression applied in the fusion layer 520 may be performed based on a filter of the compression layer 514.

Referring to FIG. 5, the electronic device may apply a filter 523 of the decompression layer 511 to a tile 522 extracted from the input data 521. The electronic device may apply the activation function and pooling 525 of the activation layer 512 and the pooling layer 513 to a result 524 of the application of the filter of the decompression layer 511. The electronic device may apply a filter 527 of the compression layer 514 to a result 526 of the application of the activation function and the pooling 525. The electronic device may obtain a result 528 of applying the filter 527 of the compression layer 514 to the result 526 of the application of the activation function and the pooling 525 as a portion of an output 529 of the fusion layer 520. The electronic device may obtain an output of fusion data by repeatedly obtaining a portion of the output 529 while changing the tile of the input data 521.

In FIG. 5, C₁ may represent a channel size of the input data 521, H₁ may represent a height size of the input data 521, and W₁ may represent a width size of the input data 521. K may represent a size of the filter 523 of the decompression layer 511, K′ may represent a size of the filter 527 of the compression layer 514, and T may represent a size of each tile (e.g., the tile 522) extracted from the input data 521. C₂ may represent a channel size of an input of the decompression layer 511, the activation layer 512, and the pooling layer 513, and a channel size of an output of the activation layer 512, the pooling layer 513, and the compression layer 514. C₃ may represent a channel size of the output 529, H₃ may represent a height size of the output 529, and W₃ may represent a width size of the output 529.

In the neural network 502, the electronic device may reduce the maximum usage of the memory without changing an operation result between the activation layer set 510 and the fusion layer 520. For example, when an input A and an input B have the same value, an output A obtained by applying the input A to the neural network 501 may have the same value as an output B obtained by applying the input B to the neural network 502. The neural network 502 may also be referred to as a compiled neural network 502.

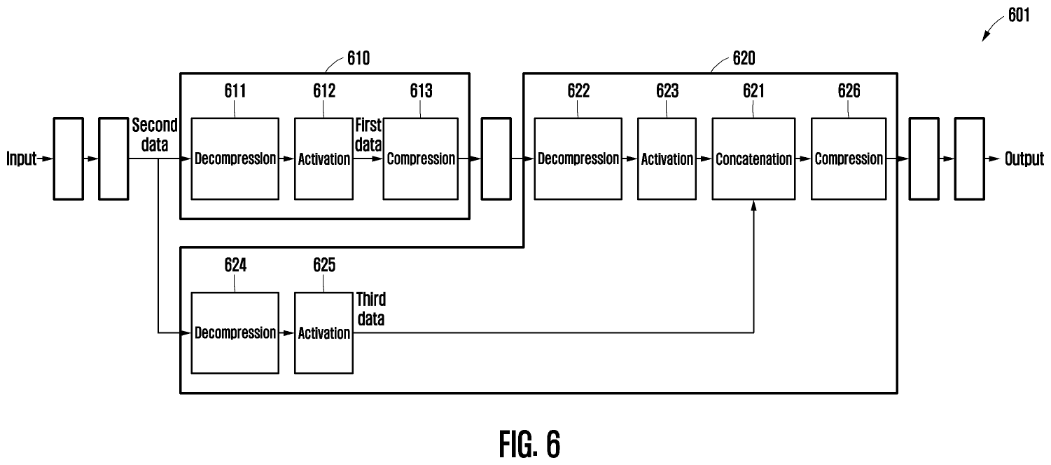

FIG. 6 illustrates an example of a neural network compilation operation of changing a detected activation layer set after changing a skip connection by an electronic device according to one or more embodiments.

Referring to FIG. 6, each illustrated block may represent a layer of a corresponding neural network. The neural network 601 of FIG. 6 may represent at least a portion of a larger neural network, or neural network 601 may represent the entire neural network.

An electronic device according to an example may obtain the neural network 601 (e.g., the neural network 302 of FIG. 3) in which a skip connection is changed, e.g., in a previous neural network compilation operation, based on a decompression layer set.

The electronic device may detect (or detect for) an activation layer set 610 including a decompression layer 611 that decompresses second data, an activation layer 612 that applies an activation function to an output of the decompression layer 611, and a compression layer 613 that compresses an output of the activation layer 612 in the neural network. The electronic device may change the detected activation layer set 610 into a fusion layer that performs decompression, application of an activation function, and compression for each of tiles extracted from the second data. As described above with reference to FIGS. 4 and 5, the electronic device may change the activation layer set 610 into the fusion layer in the neural network.

In the above discussion with respect to FIGS. 4 to 6, examples were described with respect to the electronic device changing an activation layer set including a decompression layer, an activation layer, and a compression layer into the fusion layer, however examples are not limited thereto. For example, the electronic device may also or alternatively change an activation layer set that further includes a concatenation layer 621 into a corresponding fusion layer. In various examples herein, an activation layer set including the concatenation layer 621 may be referred to as a concatenation layer set, and represented in FIG. 6 as concatenation layer set 620.

The electronic device may detect (or detect for) the concatenation layer set 620 in the neural network 601. The concatenation layer set 620 may include a decompression layer 622, an activation layer 623 that applies a first activation function to an output of the decompression layer 622, a decompression layer 624, an activation layer 625 that applies a second activation function to an output of the decompression layer 624, the concatenation layer 621 that concatenates an output of the activation layer 623 and an output of the activation layer 625, and a compression layer 626 that compresses an output of the concatenation layer 621. The electronic device may change the concatenation layer set 620 into the corresponding fusion layer.

Referring to FIG. 6, in a neural network prior to the neural network 601, a prior skip connection existed between the compression layer 613, as a previous first layer, and the concatenation layer 621, as a previous second layer, and the neural network 601 was generated by changing the prior skip connection to the illustrated skip connection of neural network 601 that transmits a result, of applying the decompression layer 624 to the second data and the activation layer 625 to the result of the decompression layer 624, to the concatenation layer 621, which represents the current second layer of the existing skip connection of the neural network 601. For example, the electronic device previously detected the decompression layer 622 and the activation layer 623 between the previous first layer (e.g., the compression layer 613) and the previous second layer (e.g., the concatenation layer 621).

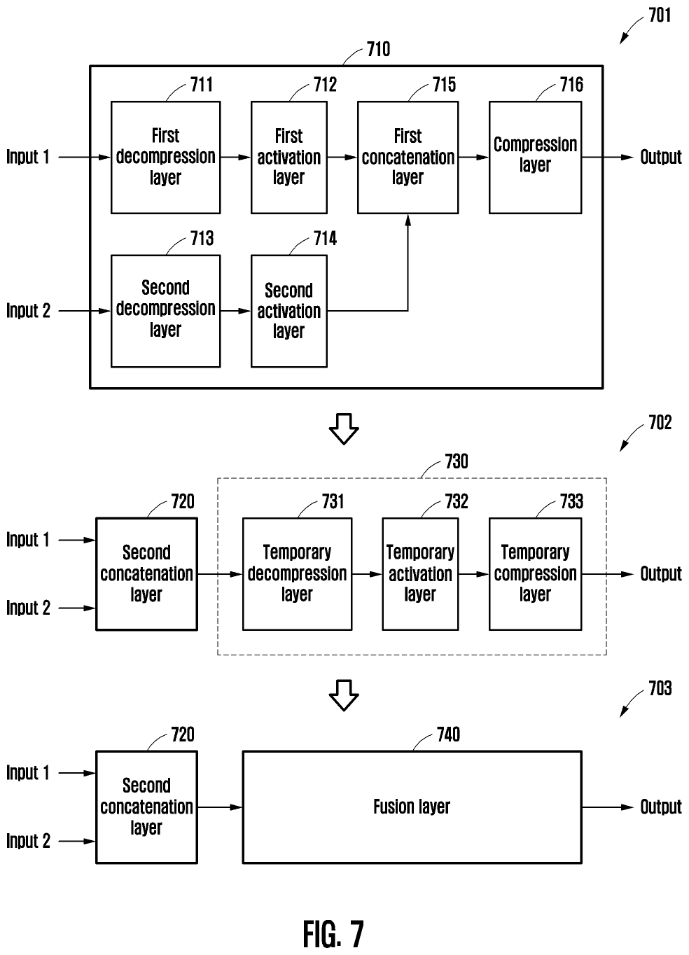

Thus, the electronic device may detect the decompression layer 624 and the activation layer 625 in a portion of the neural network 601 resulting from the previous change of the prior skip connection (or detected/determined as resulting from the previous change). When the current second layer of the existing skip connection is a concatenation layer that concatenates an output of the activation layer 623 and an output of the activation layer 625 (which resulted from the previous change of the prior skip connection), the electronic device may detect the concatenation layer set 620 rather than detecting merely another activation layer set (and making corresponding changes based on that activation layer set detection) only represented by the decompression layer 622, the activation layer 623, and the compression layer 626. Thus, when such a concatenation layer set 620 is detected in the neural network 601, the electronic device may change the concatenation layer set 620 into a corresponding fusion layer. The changing of the concatenation layer set 620 into a fusion layer will be described below in more detail with reference to FIGS. 7 to 10.

FIG. 7 illustrates an example of a neural network compilation operation of changing a concatenation layer set into a fusion layer by an electronic device when a first activation function is the same as a second activation function according to one or more embodiments.

Referring to FIG. 7, each illustrated block may represent a layer of a corresponding neural network. As a non-limiting example, the neural network 701, a neural network 702, and a neural network 703 of FIG. 7 correspond to at least a portion of an original neural network. For example, the neural network 701 may be a portion of the original neural network, the neural network 702 may correspond to a result of a neural network compilation operation performed on the neural network 701, and the neural network 703 may correspond to a result of a neural network compilation operation performed on the neural network 702.

An electronic device may detect a concatenation layer set 710 in the neural network 701. The concatenation layer set 710 may include a first decompression layer 711, a first activation layer 712 that applies a first activation function to an output of the first decompression layer 711, a second decompression layer 713, a second activation layer 714 that applies a second activation function to an output of the second decompression layer 713, a first concatenation layer 715 that concatenates an output of the first activation layer 712 and an output of the second activation layer 714, and a compression layer 716 that compresses an output of the first concatenation layer 715.

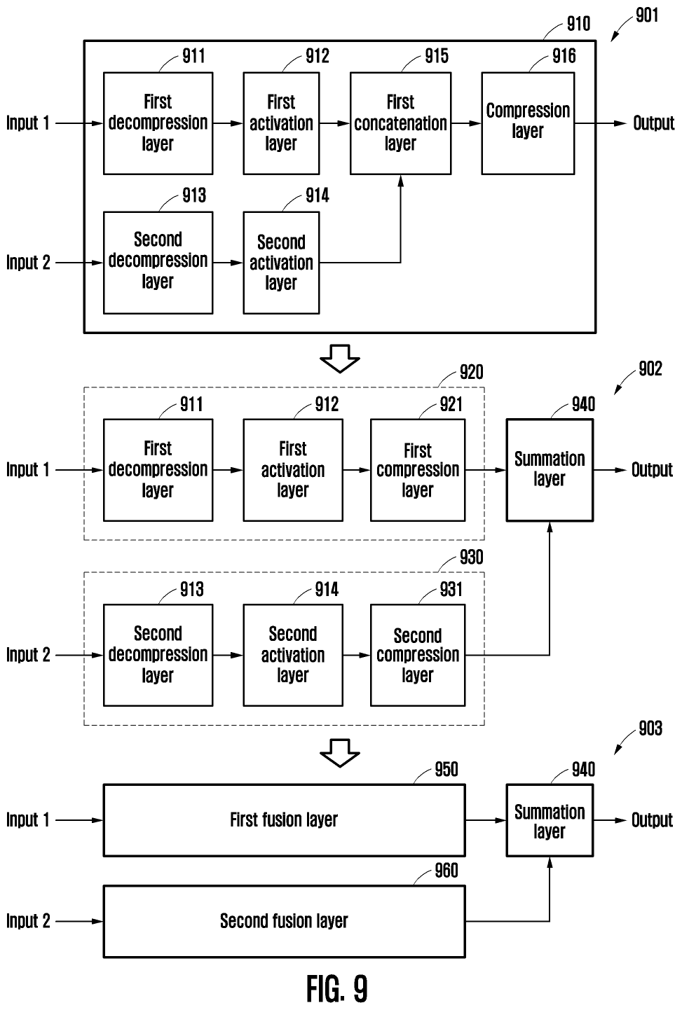

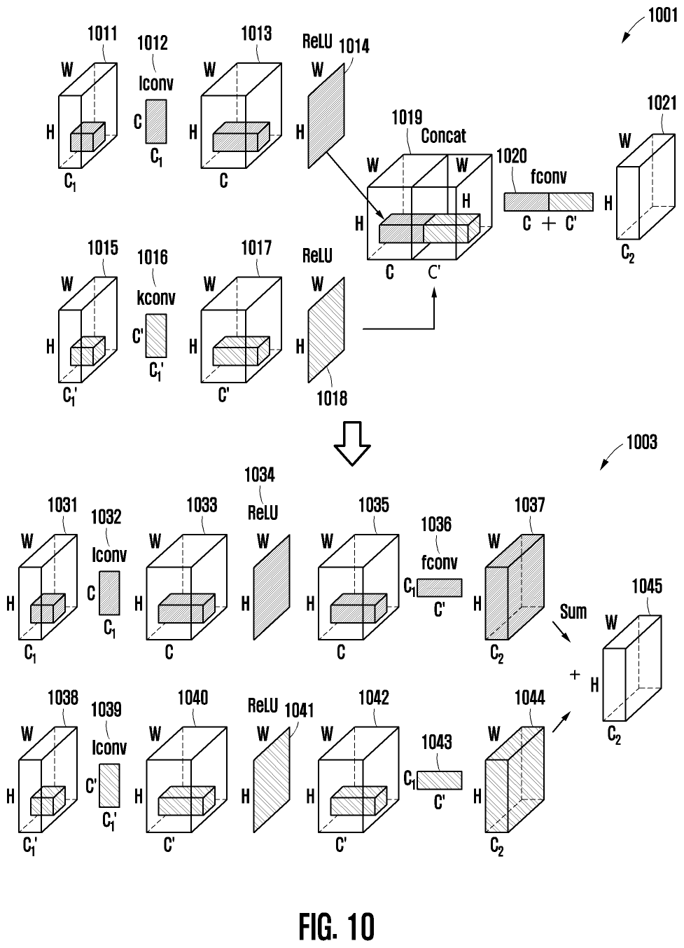

The electronic device may change the detected concatenation layer set 710 into a fusion layer 740 that performs decompression, application of an activation function, and compression for each of tiles extracted from input data. Hereinafter, the change into the fusion layer 740 when the first activation function is the same as the second activation function will be mainly described, while a change of a detected concatenation layer set into a fusion layer when a first activation function is different from a second activation function will be described below in more detail with reference to FIGS. 9 and 10.

When the first activation function is the same as the second activation function, the electronic device may replace the concatenation layer set 710 with a second concatenation layer 720 that concatenates an input (e.g., an input 1) of the first decompression layer 711 and an input (e.g., an input 2) of the second decompression layer 713, and the fusion layer 740 that performs decompression, application of the first activation function (or the second activation function), and compression for each of tiles extracted from an output of the second concatenation layer 720.

Specifically, the concatenation layer set 710 in the neural network 701 may instruct an operation such as concatenating the input (e.g., the input 1) of the first decompression layer 711 and the input (e.g., the input 2) of the second decompression layer 713 in the neural network 702 (e.g., an operation corresponding to the second concatenation layer 720), and applying a temporary activation layer set 730 to the output of the second concatenation layer 720. The temporary activation layer set 730 may include a sequence of a temporary decompression layer 731, a temporary activation layer 732, and a temporary compression layer 733.

The temporary decompression layer 731 may correspond to a convolution operation using a filter determined based on filters of the first decompression layer 711 and the second decompression layer 713. The temporary activation layer 732 may correspond to an operation of applying the first activation function or the second activation function (e.g., as the first activation function is the same as the second activation function, such as a ReLU activation). The temporary compression layer 733 may correspond to an operation such as the operation corresponding to the compression layer 716. For example, the temporary compression layer 733 may correspond to a convolution operation using a filter such as a filter used in the compression layer 716.

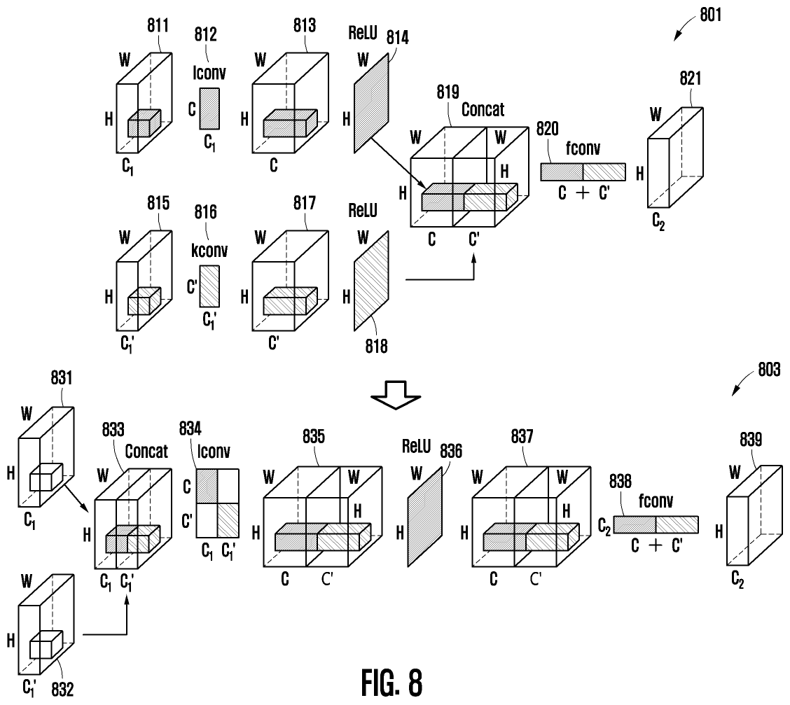

The operation corresponding to the concatenation layer set 710 being the same as the operation corresponding to the second concatenation layer 720 and the temporary activation layer set 730 will be described below in more detail with reference to FIG. 8.

As described above with reference to FIGS. 4 and 5, the temporary activation layer set 730 may be replaced with a fusion layer 740 that performs decompression, application of an activation function, and compression for each of tiles extracted from input data of the temporary activation layer set. As a result, in the neural network 703, the concatenation layer set 710 may be replaced with the second concatenation layer 720 and the fusion layer 740.

FIG. 8 illustrates an example of a concatenation layer set and a temporary activation layer set according to one or more embodiments.

In a neural network 801, an operation and/or an operation result of a concatenation layer set are shown. In a first decompression layer, data 813 in which a convolution operation using a first filter 812 is applied to a first input 811 may be output. In a first activation layer, data in which an activation function 814 is applied to the data 813 may be output. In a second decompression layer, data 817 in which a convolution operation using a second filter 816 is applied to a second input 815 may be output. In a second activation layer, data to which an activation function 818 is applied may be output. In a first concatenation layer, concatenated data 819 in which data, to which the activation function 814 is applied, and data, to which the activation function 818 is applied, are concatenated, may be output. In a compression layer, an output 821 in which a convolution operation using a third filter 820 is applied to the concatenated data 819 may be output.

In a neural network 803, an operation and/or an operation result of a concatenation layer and a temporary activation layer set are shown. In a second concatenation layer, concatenated data 833 in which a first input 831 and a second input 832 are concatenated may be output. In a temporary decompression layer, data 835 in which a convolution operation using a fourth filter 834 is applied to the concatenated data 833 may be output. In a temporary activation layer, data 837 in which an activation function 836 is applied to the data 835 may be output. In a compression layer, an output 839 in which a convolution operation using a fifth filter 838 is applied to the data 837 may be output.

As described above with reference to FIG. 7, the fourth filter 834 may be determined based on the first filter 812 and the second filter 816. The activation function 814 and the activation function 818 may be the same. The activation function 836 may be determined based on the activation function 814 and/or the activation function 818 (e.g., as the same function as the activation function 814 and/or the activation function 818). The fifth filter 838 may be determined based on the third filter 820. The fifth filter 838 may be determined as the same filter as the third filter 820.

In FIG. 8, C₁ may represent a channel size of the first input 811. C₁′ may represent a channel size of the second input 815. H may represent a height size of the first input 811 or the second input 815. W may represent a width size of the first input 811 or the second input 815. C may represent a channel size of data 813. C′ may represent a channel size of data 817.

As shown in FIG. 8, when the first input 811 and the second input 815 have the same values as the first input 831 and the second input 832, the output 821 may have the same value as the output 839.

As described above with reference to FIG. 7, in the neural network 803, the temporary activation layer set may be changed into a fusion layer.

FIG. 9 illustrates an example of a neural network compilation operation of changing a concatenation layer set into a fusion layer by an electronic device when a first activation function is different from a second activation function according to one or more embodiments.

Referring to FIG. 9, each illustrated block may represent a layer of a corresponding block. A neural network 901, a neural network 902, and a neural network 903 of FIG. 9 correspond to at least a portion of an original neural network. For example, the neural network 901 may be a portion of the original neural network, the neural network 902 may correspond to a result of a neural network compilation operation performed on the neural network 901, and the neural network 903 may correspond to a result of a neural network compilation operation performed on the neural network 902.

An electronic device may detect (or detect for) a concatenation layer set 910 in the neural network 901. The concatenation layer set 910 may include a first decompression layer 911, a first activation layer 912 that applies a first activation function to an output of the first decompression layer 911, a second decompression layer 913, a second activation layer 914 that applies a second activation function to an output of the second decompression layer 913, a first concatenation layer 915 that concatenates an output of the first activation layer 912 and an output of the second activation layer 914, and a compression layer 916 that compresses an output of the first concatenation layer 915.

The electronic device may change the detected concatenation layer set 910 into a fusion layer that performs decompression, application of an activation function, and compression for each of tiles extracted from input data.

However, when the first activation function of the first activation layer 912 is different from the second activation function of the second activation layer 914, the electronic device may replace the concatenation layer set 910 with a first fusion layer 950, a second fusion layer 960, and a summation layer 940. The first fusion layer 950 may perform decompression, application of the first activation function, and compression for each of tiles for an input (e.g., an input 1) of the first decompression layer 911. The second fusion layer 960 may perform decompression, application of the second activation function, and compression for each of tiles for an input (e.g., an input 2) of the second decompression layer 913. The summation layer 940 may sum an output of the first fusion layer 950 and an output of the second fusion layer 960.

To change the concatenation layer set 910 to the first fusion layer 950, the second fusion layer 960, and the summation layer 940, the electronic device may perform a first neural network compilation operation of changing the concatenation layer set 910 into a first temporary activation layer set 920 (e.g., applying operations to the input 1), a second temporary activation layer set 930 (e.g., applying operations to the input 2), and a summation layer 940 that may sum an output of the first temporary activation layer set 920 and an output of the second temporary activation layer set 930, in the neural network 902. As explained below, the electronic device may then perform a second neural network compilation operation of changing the first temporary activation layer set 920 into first fusion layer 950 and changing the second temporary activation layer set 930 into fusion layer 960. The first temporary activation layer set 920 may include a sequence of the first decompression layer 911, the first activation layer 912, and a first compression layer 921. The first compression layer 921 may correspond to a convolution operation using a filter determined based on a portion of a filter of the compression layer 916. The second temporary activation layer set 930 may include a sequence of the second decompression layer 913, the second activation layer 914, and a second compression layer 931. The second compression layer 931 may correspond to a convolution operation using a filter determined based on a remainder of the filter of the compression layer 916.

Thus, when the first concatenation layer 915 and the compression layer 916 of the concatenation layer set 910 in the neural network 901 are changed to the first compression layer 921, the second compression layer 931, and the summation layer 940 in the first neural network compilation operation, the one concatenation layer set 910 of neural network 901 may be replaced by the first temporary activation layer set 920, the second temporary activation layer set 930, and the summation layer 940.

The overall operations corresponding to the concatenation layer set 910 being the same as the overall operations corresponding to the first temporary activation layer set 920, the second temporary activation layer set 930, and the summation layer 940 will be described below in more detail with reference to FIG. 10.

As described above with reference to FIGS. 4 and 5, each of the first temporary activation layer set 920 and the second temporary activation layer set 930 may be replaced with a respective fusion layer that performs decompression, application of an activation function, and compression for each of a plurality of tiles extracted from input data of a corresponding temporary activation layer set. For example, the first temporary activation layer set 920 may be replaced with the first fusion layer 950. The second temporary activation layer set 930 may be replaced with the second fusion layer 960. As a result, with respect to the neural network 903, the concatenation layer set 910 of neural network 901 has been replaced with the first fusion layer 950, the second fusion layer 960, and the summation layer 940 in neural network 903.

FIG. 10 illustrates an example of a concatenation layer set, a first temporary activation layer set, and a second temporary activation layer set according to one or more embodiments.

In a neural network 1001, an operation and/or an operation result of a concatenation layer set are shown. The concatenation layer set may include a first decompression layer (including a first filter 1012), a first activation layer that applies a first activation function 1014, a second decompression layer (including a second filter 1016), a second activation layer that applies a second activation function 1018, a first concatenation layer that generates concatenated data 1019 from respective results of the applied first activation function 1014 and second activation function 1018, and a first compression layer (including a third filter 1020) that acts on the concatenated data 1019 to generate output data 1021. The first decompression layer performs a convolution operation of applying the first filter 1012 to a first input 1011 to generate the data 1013. The first activation layer applies the activation function 1014 to the data 1013. The second decompression layer performs a convolution operation of applying the second filter 1016 to a second input 1015 to generate data 1017. The second activation layer applies the activation function 1018 to the data 1017. The first concatenation layer generates concatenated data 1019 by concatenating results of the application of the activation function 1014 with results of the application the activation function 1018. The first compression layer performs a convolution operation of applying the third filter 1020 to the concatenated data 1019 to generate output data 1021.

In a neural network 1003, the operations and/or operation results of a first temporary activation layer set, a second temporary activation layer set, and a summation layer are shown.

The first temporary activation layer set may include a third decompression layer (including a fourth filter 1032), a third activation layer that applies a third activation function 1034, and a second compression layer (including a fifth filter 1036). The second temporary activation layer set may include a fourth decompression layer (including a sixth filter 1039), a fourth activation layer that applies a fourth activation function 1041, and a third compression layer (including a seventh filter 1043).

The third decompression layer performs a convolution operation by applying the fourth filter 1032 (e.g., the same filter as the first filter 1012) to a third input 1031 (the third input 1031 may be the same as the first input 1011) to generate data 1033. The third activation layer applies the third activation function 1034 (e.g., the same activation function as the activation function 1014) to the data 1033 to generate data 1035. The second compression layer performs a convolution operation by applying the fifth filter 1036 (e.g., a portion of the third filter 1020) to the data 1035 to generate data 1037.

The fourth decompression layer performs a convolution operation by applying the sixth filter 1039 (e.g., the same filter as the second filter 1016) to a fourth input 1038 (the fourth input 1038 may be the same as the second input 1015) to generate data 1040. The fourth activation layer applies the fourth activation function 1041 (e.g., the same activation function as the activation function 1018) to the data 1040 to generate data 1042. The third compression layer performs a convolution operation by applying a seventh filter 1043 (e.g., the remainder of the third filter 1020) to the data 1042 to generate data 1044.

In a summation layer, the data 1037 may be summed with the data 1044 to generate data 1045.

As shown in FIG. 10, when the first input 1011 and the second input 1015 have the same values as the third input 1031 and the fourth input 1038, respectively, the output 1021 may have the same value as the output 1045.

In FIG. 10, C₁ may represent a channel size of the first input 1011. C₁′ may represent a channel size of the second input 1015. H may represent a height size of the first input 1011 or the second input 1015. W may represent a width size of the first input 1011 or the second input 1015. C may represent a channel size of data 1013. C′ may represent a channel size of data 1017.

As described above in FIG. 9, each of the first temporary activation layer set and/or the second temporary activation layer set may be changed into a respective fusion layer (e.g., a first fusion layer and a second fusion layer).

FIG. 11 illustrates an example of an electronic device according to one or more embodiments.

According to an example, an electronic device 1100 may include a processor 1110, a memory 1120, and a communication interface 1130. The processor 1110 may represent one or more processors and memory 1120 may represent one or more memories. The processor 1110 may be configured perform any one, any combination, or all operations described above with respect to FIGS. 1-10. In an example, the memory may store code that, when executed by the processor 1110, configure or cause the processor 1110 to perform any one, any combination, or all operations described above with respect to FIGS. 1-10. The electronic device 1100 may correspond to any, any combination, or all of the electronic devices described above with respect to FIGS. 1-10.

The processor 1110 may obtain information about a neural network. For example, the processor 1110 may read hyperparameter information of the neural network from the memory 1120. The processor 1110 may detect a skip connection. The processor 1110 may determine a decompression layer set. The processor 1110 may change the skip connection. The processor 1110 may detect an activation layer set. The processor 1110 may change the activation layer set into a fusion layer.

The memory 1120 may temporarily and/or permanently store at least one of a neural network, each layer, a skip connection, an activation layer set, a decompression layer set, and/or a fusion layer, such as in respective parameters (including weights and/or hyperparameters defining their respective structures) of the same, and/or through programming code respectively defining the same. The memory 1120 may store code that when executed by the processor 1110 may cause or configure the processor 1110 to perform an operation of detecting a skip connection, an operation of determining a decompression layer set, an operation of changing the skip connection based on the decompression layer set, an operation of detecting an activation layer set, an operation of changing the activation layer set into a fusion layer, and/or an operation of changing a concatenation layer set into a fusion layer, as well any one, any combination, or all operations described herein. The memory 1120 may further temporarily and/or permanently store the compiled instructions, such a described with respect to FIG. 4, including those respectively resulting from the neural network compilation operations described herein. For example, in an example, the processor 1110 may implement or execute the neural network with respect to one or more inputs (e.g., otherwise generated by the processor 1110 or read from the memory 1120) by executing the compiled instructions. The memory 1120 may further represent the local and global memories described herein. However, these are merely examples, and information stored in the memory 1120 is not limited thereto.

The communication interface 1130 may transmit and receive at least one of a neural network, each layer, a skip connection, an activation layer set, a decompression layer set, and/or a fusion layer. The communication interface 1130 may include any well-known interface or other hardware configured to establish a wired communication channel and/or a wireless communication channel with an external device (e.g., a processing device, another electronic device, or a server), and for example, may include one or more transceivers or other hardware interfaces configured to establish and/or perform cellular communication, short-range wireless communication, a local area network (LAN) communication, Bluetooth™, wireless-fidelity (Wi-Fi) direct, or infrared data association (IrDA), communication through a long-range communication network, such as a legacy cellular network, a 4G and/or 5G network, a next-generation communication, the Internet, or a computer network (e.g., a LAN or a wide area network (WAN)), with the external device.

The electronic devices, processors, memories and communication interfaces described herein, including descriptions with respect to respect to FIGS. 1-11, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both, and thus while some references may be made to a singular processor or computer, such references also are intended to refer to multiple processors or computers. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in, and discussed with respect to, FIGS. 1-11 that perform the operations described in this application are performed by computing hardware, for example, by one or more processors or computers, implemented as described above implementing instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations. References to a processor, or one or more processors, as a non-limiting example, configured to perform two or more operations refers to a processor or two or more processors being configured to collectively perform all of the two or more operations, as well as a configuration with the two or more processors respectively performing any corresponding one of the two or more operations (e.g., with a respective one or more processors being configured to perform each of the two or more operations, or any respective combination of one or more processors being configured to perform any respective combination of the two or more operations). Likewise, a reference to a processor-implemented method is a reference to a method that is performed by one or more processors or other processing or computing hardware of a device or system.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processor-implemented method, the method comprising:
detecting for a skip connection in a neural network, where the skip connection is configured to output first data to a second layer in the neural network, wherein the first data is output from a first layer in the neural network, and wherein the second layer is beyond a hierarchically subsequent layer of the first layer in the neural network;
determining, in the neural network, a decompression layer set comprising a layer, which is configured in the neural network to be input second data with a dimension smaller a dimension of the first data, that is among one or more layers hierarchically preceding the first layer in the neural network; and
generating a compiled version of the neural network by changing the skip connection dependent on the determined decompression layer set.

2. The method of claim 1, wherein the determining of the decompression layer set comprises:
detecting, among the one or more layers, the layer as a decompression layer that is configured to be input data having a dimension smaller than the dimension of the first data by more than a threshold dimension; and
determining all layers, sequentially from the decompression layer to the first layer in the neural network, as the decompression layer set.

3. The method of claim 1, wherein the changing of the skip connection comprises:
changing the detected skip connection, from the output of the first data from the first layer to the second layer, into a different skip connection using a copied layer set, which is a copy of the determined decompression layer set, that is configured to be input the second data and provide third data output from the copied layer set to the second layer.

4. The method of claim 1, further comprising:
detecting, in the neural network, for an activation layer set comprising a decompression layer that is configured to decompresses the second data, an activation layer that is configured to apply an activation function to an output of the decompression layer, and a compression layer that is configured to compress an output of the activation layer in the neural network,
wherein the generating of the compiled version of the neural network further comprises changing the detected activation layer set into a fusion layer that is configured in the compiled version of the neural network to perform decompression, application of an activation function, and compression for each of tiles extracted from the second data.

5. The method of claim 4,
wherein the detecting for the activation layer set comprises detecting for a concatenation layer set comprising a first decompression layer, a first activation layer that is configured to apply a first activation function to an output of the first decompression layer, a second decompression layer, a second activation layer that configured to apply a second activation function to an output of the second decompression layer, a first concatenation layer that is configured to concatenate an output of the first activation layer and an output of the second activation layer, and a compression layer that is configured to compress an output of the first concatenation layer in the neural network, and
wherein:
the changing of the detected activation layer set comprises changing the detected concatenation layer set into the fusion layer, with the first decompression layer being the decompression layer, the first activation layer being the activation layer, and the first compression layer is the compression layer; or
wherein the generating of the compiled version of the neural network further comprises changing the detected concatenation layer set into another fusion layer that is configured to performs a corresponding decompression, application of a corresponding activation function, and corresponding compression for each of tiles extracted from data that was configured in the neural network to be input to the concatenation layer set.

6. The method of claim 5,
wherein, in response to a determination that the second layer is configured to concatenate an output of the first activation layer and an output of the second activation layer, detecting the second layer as the first concatenation layer and performing the changing of the detected concatenation layer set into the fusion layer, where the performing of the changing of the detected concatenation layer set into the fusion layer occurs after the changing of the skip connection,
wherein changed skip connection is configured to input the second data to the second decompression layer, and output a result of the second activation layer to the second layer, and
wherein the detecting for the concatenation layer set comprises:
detecting for the first decompression layer and the first activation layer between the first layer and the second layer in the neural network; and
detecting for the second decompression layer and the second activation layer in the changed skip connection.

7. The method of claim 1, further comprising:
detecting for a concatenation layer set comprising a first decompression layer, a first activation layer that is configured to apply a first activation function to an output of the first decompression layer, a second decompression layer, a second activation layer that configured to apply a second activation function to an output of the second decompression layer, a first concatenation layer that is configured to concatenate an output of the first activation layer and an output of the second activation layer, and a compression layer that is configured to compress an output of the first concatenation layer in the neural network, where the detection of the second decompression layer and the detection of the second activation layers are performed after performance of the changing the skip connection; and
in response to the first activation function being determined to be same as the second activation function, replacing the concatenation layer set with a second concatenation layer that is configured to concatenate an input of the first decompression layer and an input of the second decompression layer, and a fusion layer that is configured to perform decompression, application of the first activation function, and compression for each of tiles extracted from an output of the second concatenation layer.

8. The method of claim 1, further comprising:
detecting for a concatenation layer set comprising a first decompression layer, a first activation layer that is configured to apply a first activation function to an output of the first decompression layer, a second decompression layer, a second activation layer that configured to apply a second activation function to an output of the second decompression layer, a first concatenation layer that is configured to concatenate an output of the first activation layer and an output of the second activation layer, and a compression layer that is configured to compress an output of the first concatenation layer in the neural network, where the detection of the second decompression layer and the detection of the second activation layers are performed after performance of the changing the skip connection; and
in response to a determination that the first activation function is different from the second activation function, replacing the concatenation layer set with a first fusion layer that is configured to perform decompression, application of the first activation function, and compression for each of tiles for an input of the first decompression layer, a second fusion layer that is configured to perform decompression, application of the second activation function, and compression for each of tiles for an input of the second decompression layer, and a summation layer that is configured to sum an output of the first fusion layer and an output of the second fusion layer.

9. The method of claim 1, wherein the detecting for the skip connection comprises, in response to a determination that the neural network is configured to use the first data in the second layer after the first data is output by the first layer, detecting for the skip connection between the first layer and the second layer based on a determined hierarchical distance between the first layer and the second layer.

10. The method of claim 1, wherein, with the neural network comprising the skip connection, the generating of the compiled version of the neural network further comprises determining whether to change the skip connection based on a result of a comparing of a computational load of a copied layer set, which is a copy of the determined decompression layer set, with a threshold computation overhead.

11. The method of claim 1, wherein, with the neural network comprising the skip connection, the generating of the compiled version of the neural network further comprises determining whether to change the skip connection based on a result of a comparing of memory usage of a copied layer set, which is a copy of the determined decompression layer set, with a threshold memory overhead.

12. A non-transitory computer-readable storage medium storing code that, in response to being executed by one or more processors, cause the one or more processors to perform the method of claim 1.

13. A processor-implemented method, the method comprising:
detecting for an activation layer set in a neural network, the activation layer set comprising a decompression layer that is configured to decompresses input data, an activation layer that is configured to apply an activation function to an output of the decompression layer, and a compression layer that is configured to compress data that is based on an output of the activation layer; and
generating a compiled version of the neural network by changing the activation layer set into a fusion layer that is configured to perform decompression, application of an activation function, and compression for each of tiles that are dependent of the input data.

14. The method of claim 13,
wherein the detecting for the activation layer set comprises detecting for the decompression layer, the activation layer, a pooling layer that that is configured to apply a pooling to the output of the activation layer, and the compression layer that is configured to compresses an output of the pooling layer, and
wherein the fusion layer is further configured to perform an application of pooling.

15. The method of claim 13, wherein
the detecting for the activation layer set comprises detecting for a concatenation layer set comprising a first decompression layer, a first activation layer that is configured to apply a first activation function to an output of the first decompression layer, a second decompression layer, a second activation layer that is configured to apply a second activation function to an output of the second decompression layer, a first concatenation layer that is configured to concatenate an output of the first activation layer and an output of the second activation layer, and the compression layer that is configured to compress an output of the first concatenation layer in the neural network, and
wherein the changing of the activation layer set comprises changing the concatenation layer set into the fusion layer.

16. The method of claim 13,
wherein the detecting for the activation layer set further comprises detecting for a concatenation layer set comprising a first decompression layer, a first activation layer that is configured to apply a first activation function to an output of the first decompression layer, a second decompression layer, a second activation layer that configured to apply a second activation function to an output of the second decompression layer, a first concatenation layer that is configured to concatenate an output of the first activation layer and an output of the second activation layer, and the compression layer that is configured to compress data that is based on an output of the first concatenation layer in the neural network, and
wherein the changing of the activation layer set comprises, in response to a determination that the first activation function is same as the second activation function, replacing the concatenation layer set with a second concatenation layer that is configured to concatenate an input of the first decompression layer and an input of the second decompression layer, and the fusion layer that is configured to perform an application of the first activation function as the application of the activation function, and the compression for each of the tiles that are extracted from an output of the second concatenation layer.

17. The method of claim 13,
wherein the detecting for the activation layer set further comprises detecting for a concatenation layer set comprising a first decompression layer, a first activation layer that is configured to apply a first activation function to an output of the first decompression layer, a second decompression layer, a second activation layer that configured to apply a second activation function to an output of the second decompression layer, a first concatenation layer that is configured to concatenate an output of the first activation layer and an output of the second activation layer, and the compression layer that is configured to compress data that is based on an output of the first concatenation layer in the neural network, and
wherein the changing of the activation layer set comprises, in response to a determination that the first activation function is different from the second activation function, replacing the concatenation layer set with a first fusion layer that is configured to perform decompression, application of the first activation function, and compression for each of tiles for an input of the first decompression layer, a second fusion layer that is configured to perform decompression, application of the second activation function, and compression for each of tiles for an input of the second decompression layer, and a summation layer that is configured to sum an output of the first fusion layer and an output of the second fusion layer.

18. The method of claim 13, wherein the generating of the compiled version of the neural network further comprises changing a detected skip connection, based on a determined decompression layer set, before the changing of the activation layer set.

19. An electronic device comprising:
one or more processors; and
a memory storing code,
wherein the code is configured to, in response to being executed by the one or more processors, cause the one or more processors to:
detect for a skip connection in a neural network, where the skip connection is configured to output first data to a second layer in the neural network, wherein the first data is output from a first layer in the neural network, and wherein the second layer is beyond a hierarchically subsequent layer of the first layer in the neural network;
determine, in the neural network, a decompression layer set comprising a layer, which is configured in the neural network to be input second data with a dimension smaller a dimension of the first data, that is among one or more layers hierarchically preceding the first layer in the neural network; and
generate a compiled version of the neural network by changing the skip connection dependent on the determined decompression layer set.

20. The electronic device of claim 19, wherein, for the changing of the skip connection, the instructions are configured to, in response to being executed by the processor, cause the one or more processors to:
change the detected skip connection, from the output of the first data from the first layer to the second layer, into a different skip connection using a copied layer set, which is a copy of the determined decompression layer set, that is configured to be input the second data and provide third data output from the copied layer set to the second layer.

21. The electronic device of claim 19, wherein the code is configured to, in response to being executed by the one or more processors, cause the one or more processors to:
detect, in the neural network, for an activation layer set comprising a decompression layer that is configured to decompresses the second data, an activation layer that is configured to apply an activation function to an output of the decompression layer, and a compression layer that is configured to compresses an output of the activation layer in the neural network,
wherein the generation of the compiled version of the neural network further comprises a changing of the detected activation layer set into a fusion layer that is configured in the compiled version of the neural network to perform decompression, application of an activation function, and compression for each of tiles extracted from the second data.
